(19) United States
(12) Patent Application Publication
(10) Pub. No.: US 2006/0265836 A1
(43) Pub. Date: Nov. 30, 2006

(54) Connection apparatus applicable to electronic device having hinge

(75) Inventors: Yung-Chi Yang, Taipei (TW); Ling-Li Li, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/394,427

(22) Filed: Mar. 31, 2006

(30) Foreign Application Priority Data
May 30, 2005 (TW) 94208888

(51) Int. Cl. E05D 7/00

(52) U.S. Cl. 16/221

(57) ABSTRACT

A connection apparatus applicable to an electronic device having a hinge is disclosed. The connection apparatus has at least a plurality of fixing members, at least a connecting member, and a plurality of fastening members. Each of the fixing members has a first sleeve part provided on a top end thereof. The connecting member has a plurality of second sleeve parts corresponding to the first sleeve parts. By fitting the first sleeve parts into their corresponding second sleeve parts, the overall thickness of the connection apparatus is reduced, and the effective engaging length and strength of the fixing members and the fastening members are increased.

### FIELD OF THE INVENTION

The present invention relates to a connection apparatus, and more particularly, to a connection apparatus applied to an electronic device having a hinge.

### BACKGROUND OF THE INVENTION

Notebooks having the advantages of light and thin physical characteristics and powerful functions are becoming one of the most popular portable computers.

Generally, the trend of portable computers is moving towards ever lighter and thinner computers, besides providing a diversity of functions. Most 12-inch notebook computers in the market have been developed to be only 2 centimeters in thickness. Therefore, pursuing lightweight and thin appearance has become the main stream of notebook development.

For the manufacturers of notebook computers, the main method to realize these goals is to reintegrate the components within the machine and to compress the space occupied by the components as much as possible. However, this leads to some undesirable influence of the related structures within the notebook computers, especially the connection strength of hinges.

As shown in FIG. 1, a conventional hinge 1 applied in a notebook computer is used to connect a computer host (not shown) with a display panel 2 for providing a collapsible function. In order to prevent the hinge 1 from damage caused by torque generated when the display panel 2 is lifted or closed, the hinge 1 usually is not directly connected to the computer host and the display panel 2, but instead through a connection apparatus to connect the computer host with the display panel 2, so as to disperse the torque generated when the display panel 2 is lifted to prevent damage by stress concentration.

The connection apparatus includes a connecting member 3, a plurality of fixing members 21 installed in predetermined regions of the display panel 2, and a plurality of fastening members 4 for fastening the connecting member 3 to the fixing members 21. The connecting member 3 is in the shape of “L” and is to be installed in a corner region of the display panel 2. The connecting member 3 has a plurality of through holes 31. The fixing members 21 vertically protrude from the surface of predetermined regions of the display panel 2, and each has a screw hole 23. The fastening members 4 are for example screws for passing through the through hole 31 and engaging with the screw hole 23, so as to fasten the connecting member 3 onto the fixing members 21 of the display panel 2.

As shown in FIG. 2, the conventional connecting member 3 and the fixing members 21 of the connection apparatus are designed in stack. Therefore, the total thickness of the connecting member 3 and the fixing members 21 is at least the summation of the thickness of the connecting member 3 and the height of one fixing member 21, which limits the ability to become thinner. Further, as shown, the connecting member 3 between one of the fastening members 4 and one of the fixing members 21 occupies a portion of the fastening member 4, thus reducing the fastening length between the fastening member 4 and the fixing member 21, and in turn affecting the connection stability of the connecting member 3. As a result, the risk of loosening or shedding of the connecting member 3 is higher. For example, assume the fastening member 4 is a screw having nine threads, after subtracting the thickness of the connecting member 3 by three threads, the remaining threads that are actually engaged with the screw hole 23 is six, thus reducing the fastening strength.

Further, due to the stack design of the connecting member 3 and the fixing members 21, searching for the precise positions for the various through holes 31 and the corresponding screw holes 23 is inconvenient and time-consuming during assembling.

The hinge for the display panel is the primarily movable component of the notebook computer. Therefore, the endured torque is relatively larger than any other component. Moreover, the display panel of the notebook computer has a certain weight, thus a certain level of the fastening strength between the display panel and the hinge is required.

For pursuing the goals of lightweight and thin thickness, manufacturers of the notebook computers have to compress the space occupied by the components. Therefore, the height of the fixing members of the display panel or the computer host used to connect with the connecting members has to be reduced, which relatively shortens the depth of the screw holes as mentioned, thus the effective length of the screws and the screw holes will be obviously shorter. It reduces the fastening strength, thus the goal of lightweight and thin thickness of a notebook computer is hard to achieve.

Therefore, there is a need for providing a connection apparatus for a hinge to achieve a thinner thickness of the whole connection apparatus for a hinge without affecting the fastening length.

### SUMMARY OF THE INVENTION

In light of the above drawbacks in the prior art, the primary objective of the present invention is to provide a connection apparatus applicable to an electronic device having a hinge so that the overall thickness of the connection apparatus is reduced.

Another objective of the present invention is to provide a connection apparatus applicable to an electronic device having a hinge having a longer effective engaging length between a fixing member and a fastening member.

Still another objective of the present invention is to provide a connection apparatus applicable to an electronic device having a hinge that is easy to be assembled to a hinge of an electronic device.

In accordance with the above objectives, the present invention proposes a connection apparatus applicable to an electronic device having a hinge, the connection apparatus including a plurality of fixing members, at least a connecting member and a plurality of fastening members. The fixing members are provided on predetermined positions of the electronic device and protruding vertically from the surface thereof. Each of the fixing members has a first sleeve part provided on the top. The connecting member has a joint part for connection to the hinge and a plurality of second sleeve parts corresponding to the predetermined positions and the number of the fixing members, wherein the first sleeve parts are fitted into the second sleeve parts. The fastening members are used to fasten the connecting member to the fixing members.

Each of the fixing members may have a tubular structure and an engaging hole passing through the top thereof. Preferably, the engaging hole is a screw hole.

The first sleeve parts and its corresponding fixing members may together form stair-shaped structures. The second sleeve part is a through hole for enclosing the corresponding first sleeve part. Each of the fastening members has a pressing part for pressing and fixing the connecting member. The pressing part may have a structure outward extended from the top of the fastening member. Preferably, the fastening member is a screw.

The connection apparatus further includes two connecting members connected to a first end and a second end of the hinge, the electronic device has a first unit and a second unit, both of which are able to be connected via the hinge, and the fixing members are provided on predetermined positions inside of the first unit and the second unit and protruding vertically from the first unit and the second unit. Preferably, the first unit is a computer host, the second unit is a display panel, and the electronic device is a notebook computer.

The connection apparatus of the present invention essentially forms first sleeve parts on the top of the fixing members and can be fitted into the corresponding second sleeve part on the connecting member. By fitting the first sleeve parts into the second sleeve parts, the overall thickness of the connection apparatus for a hinge is reduced, while the effective fastening length and strength between the fixing members and the fastening members are maximized. Further, the second sleeve parts can be coupled easily with the first sleeve parts in the right position, which effectively improves the convenience during assembling.

### BRIEF DESCRIPTION OF THE DRAWINGS

FIG. 1 (PRIOR ART) is an explosive view of a connection apparatus applicable to a hinge of an electronic device according to the prior art;

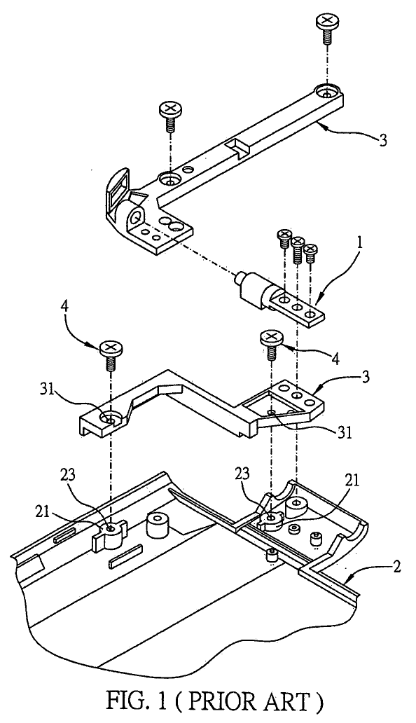

FIG. 2 (PRIOR ART) is a cross-sectional schematic diagram of the connection apparatus shown in FIG. 1;

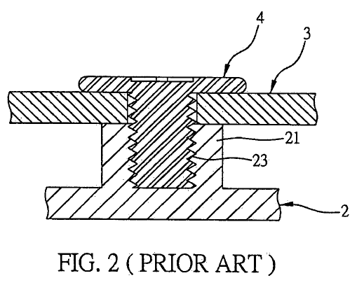

FIG. 3 is an explosive view of a preferred embodiment of the connection apparatus according to the present invention; and

FIG. 4 is a cross-sectional schematic diagram of the connecting apparatus shown in FIG. 3.

### DETAILED DESCRIPTION OF THE PREFERRED EMBODIMENTS

The present invention provides a connection apparatus used in an electronic device having a hinge. The electronic device has at least a first unit and a second unit, both of which are able to be connected via the hinge, the hinge allowing the first unit and the second unit to pivot. If the electronic device to which the present invention is applied is a notebook computer, the first unit is a computer host, and the second unit is a display panel. However, the present invention is not limited to be applied to a notebook computer.

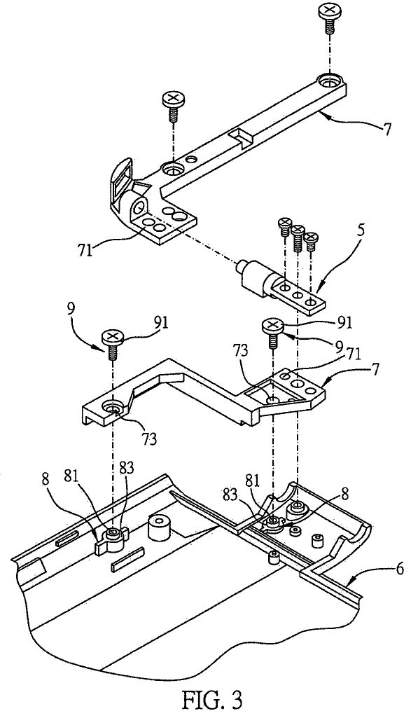

FIG. 3 is an explosive view of a preferred embodiment of the connection apparatus according to the present invention. The connection apparatus is applicable to an electronic device 6 having a hinge 5. The connection apparatus comprises a connecting member 7 connected with the hinge 5, a plurality of fixing members 8 installed on predetermined positions of the electronic device 6 and protruded above the surface of the electronic device 6, and a plurality of fastening members 9 for fastening to the fixing members 8, so as to press and fix the connecting member 7 in place. The connecting member 7 is designed according to the electronic device 6. If the electronic device 6 is a notebook computer, the connecting member 7 is designed generally in the shape of “L” approximately, and has a slightly different first end and a second end for connection of the computer host and the display panel to the hinge 5. Since the slight differences of the L-shaped connecting member 7 does not affect the structure design of the connecting member and are conventional, further description thereof is thus omitted.

The fixing members 8 are provided as vertical protrusions on the predetermined positions of the electronic device 6 for connecting the connecting member 7 to the first and second units of the electronic device 6, that is, the computer host and the display panel in the case of a notebook computer. Each of the fixing members 8 has a tubular structure and has an engaging hole 81 passing through the top end of the fixing member 8 for fastening to a corresponding one of the fastening members 9. According to the preferred embodiment, the engaging hole 81 is a screw hole. A plurality of first sleeve parts 83 are formed on the top of the fixing members 8. The first sleeve part 83 and the fixing member 8 together form a stair-shaped structure, wherein the first sleeve part 83 has a smaller diameter than that of the fixing member 8.

The connecting members 7 is to be installed in a corner of the first unit and the second unit of the electronic device 6, or the corner of the computer host and the display panel if the electronic device 6 is the notebook computer for example. The connecting member 7 has a joint part 71 for connecting with one end (the first end or the second end) of the hinge 5. The joint part 71 is for example a through hole to engage with a rivet, a screw hole to engage with a screw, or any other joints formed by the punching method. A plurality of second sleeve parts 73 corresponding to the predetermined positions and the number of the fixing members 8 are provided on the connecting members 7. Each of the second sleeve parts 73 is a through hole corresponding to the first sleeve part 83 in shape and slightly large in size, such that the respective second sleeve parts surround the corresponding first sleeve parts 83 of the fixing members 8.

The fastening member 9 is used to be fastened from the top end of the fixing member 8. The fastening member 9 has a pressing part 91 for pressing and fixing the fastening member 7. The pressing part 91 has a structure that outwardly extends from the top of the fastening member 9. In the preferred embodiment, the engaging hole 81 of the fixing member 8 is a screw hole, the fastening member 9, which has a pressing part 91, is a screw. It should be understood that the fastening member 9 is not limited to a screw, but any equivalent variation of the fastening member 9 for easily fastening and unfastening is construed as to fall in the scope of the present invention. For example, the fastening member 9 can be a tenon while the engaging hole 81 be a corresponding mortise, or the fastening member 9 can be a protrusion while the engaging hole 81 be a corresponding guiding groove.

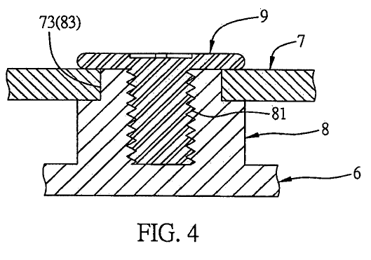

As shown in FIG. 4, during assembling, the connecting member 7 is firstly placed on the fixing members 8 on for example the first unit of the electronic device 6, such that the first sleeve parts 83 of the fixing members 8 are fitted into the corresponding second sleeve parts 73, thereby the connecting member 7 is positioned on the corresponding fixing members 8 of the electronic device 6. Subsequently, the pressing part 91 of the fastening members 9 are pressed through the second sleeve parts 73 of the connecting member 7 into the corresponding engaging hole 81 of the fixing member 8.

As shown in FIG. 4, in the connection apparatus of the present invention, since the connecting member 7 and fixing members 8 are not designed in stack, but are positioned by the use of the second sleeve part 73 enclosing around the first sleeve part 83 on the same level, the total thickness of the connecting apparatus after the connecting member 7 has been fixed to the fixing members 8 of the electronic device 6 is only the thickness of the fixing member 8 plus the fastening member 9 (without the thickness of the connecting member 7). Therefore, a reduced thickness of the connection apparatus for a hinge is achieved.

The maximum effective fastening length between the fastening member 9 (the screw for example) and the fixing member 8 can be fully utilized and in turn the connection stability of the connecting member 7 enhanced, preventing the risk of loosening and shedding of the connecting member 7. Furthermore, since the first sleeve parts 83 are designed to just fit into the second sleeve parts 73, the second sleeve part 73 can be engaged with the first sleeve part 83 easily in the right position, so as to effectively improve the convenience during assembling. Obviously, in order to provide an easier positioning effect, there can also be a certain gap between the second sleeve part 73 and the first sleeve part 83 to absorb overlapping error.

Since the connecting member 7 and fixing member 8 of the present invention are not designed in stack, the present invention reduces the overall thickness of the connecting apparatus while maximizing and the effective fastening length and strength, and it is obviously useful and advantageous to the electronic devices.

In conclusion, the connection apparatus of the present invention forms first sleeve parts on the top of the fixing members and the corresponding second sleeve part on the connecting member. By coupling the second sleeve parts around the first sleeve parts, the thinner connection apparatus for a hinge is achieved, while increasing the fastening length of the fixing member and the fastening member for enhancing the fastening strength. Further, the second sleeve parts can be coupled easily with the first sleeve parts in the right position, which effectively improves the convenience during assembling. Therefore, the connection apparatus provided by the present invention overcomes defects of the conventional technique and has several substantial improvements and highly industrial applicability.

The present invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A connection apparatus applicable to an electronic device having a hinge, the connection apparatus comprising:
a plurality of fixing members provided on predetermined positions of the electronic device and protruding vertically from a surface of the electronic device, each of the fixing members comprising a first sleeve part on a top end thereof;
at least a connecting member comprising a joint part for connection to the hinge and a plurality of second sleeve parts corresponding to the predetermined positions and the number of the fixing members, the first sleeve parts being fitted into the corresponding second sleeve parts; and
a plurality of fastening members for fastening the top ends of the fixing members, so as to press and fix the connecting member.

2. The connection apparatus of claim 1, wherein the fixing members comprise tubular structures.

3. The connection apparatus of claim 1, wherein each of the fixing members further comprises an engaging hole penetrating the top end thereof.

4. The connection apparatus of claim 3, wherein the engaging hole is a screw hole.

5. The connection apparatus of claim 1, wherein each of the first sleeve parts and its corresponding fixing member form a stair-shaped structure.

6. The connection apparatus of claim 1, wherein each of the second sleeve parts is a through hole.

7. The connection apparatus of claim 1, wherein each of the fastening members has a pressing part for pressing and fixing the connecting member.

8. The connection apparatus of claim 7, wherein the pressing part comprises a structure that is extended outwards from a top end of the corresponding fastening member.

9. The connection apparatus of claim 1, wherein the fastening members comprise screws.

10. The connection apparatus of claim 1, comprising two connecting members connected to a first end and a second end of the hinge, wherein the electronic device comprises a first unit and a second unit, both of which are capable of being connected via the hinge to the connection apparatus, and the fixing members are provided on the predetermined positions inside of the first unit and the second unit and protrude vertically from surfaces of the first unit and the second unit.

11. The connection apparatus of claim 10, wherein the first unit is a computer host, and the second unit is a display panel.

12. The connection apparatus of claim 1, wherein the electronic device is a notebook computer.
